(19) United States
(12) Patent Application Publication
(10) Pub. No.: US 2025/0307873 A1
(43) Pub. Date: Oct. 2, 2025

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Rui KONDO, Tokyo (JP); Yasuhiko YOSHIDA, Tokyo (JP); Shinnosuke NISHIMOTO, Tokyo (JP)

(73) Assignee: NEC Corporation, Tokyo (JP)

(21) Appl. No.: 19/087,709

(22) Filed: Mar. 24, 2025

(30) Foreign Application Priority Data
Mar. 28, 2024 (JP) 2024-053504

(51) Int. Cl. G06Q 30/0251; G06F 3/0482

(52) U.S. Cl. CPC G06Q 30/0255; G06F 3/0482

(57) ABSTRACT

An information processing apparatus includes: a memory that stores instructions; and a processor that is configured to execute the instructions to acquire avatar information including an appearance of an avatar linked to a user, estimate attributes of the avatar on the basis of the avatar information, and output request information for requesting content to be displayed for the user in a virtual space on the basis of the attributes.

### INCORPORATION BY REFERENCE

This application is based upon and claims the benefit of priority from Japanese patent application No. 2024-053504, filed on Mar. 28, 2024, the disclosure of which is incorporated herein in its entirety by reference.

### TECHNICAL FIELD

The present disclosure relates to an information processing apparatus, an information processing method, and a non-transitory computer readable medium.

### BACKGROUND ART

International Patent Publication No. WO2022/113520 and Japanese Unexamined Patent Application Publication No. 2009-223745 disclose techniques for users to experience virtual spaces via avatars which are other selves of the users in a metaverse. In recent years, advertisement business in the metaverse has attracted attention with progress in techniques related to the metaverse. Development of a technique for optimizing content of advertisements in the metaverse has been expected.

### SUMMARY

It is difficult for metaverse operators to recognize information regarding users that can be provided to advertisers.

Thus, an example object to be achieved by example embodiments disclosed in the specification is to provide an information processing apparatus, an information processing method, and a non-transitory computer readable medium capable of suitably recognizing information regarding users that can be provided to advertisers and the like in a metaverse.

An information processing apparatus according to a first example aspect includes:
at least one memory that stores instructions; and
at least one processor that is configured to execute the instructions to;
acquire avatar information including an appearance of an avatar linked to a user,
estimate attributes of the avatar on the basis of the avatar information, and
output request information for requesting content to be displayed for the user in a virtual space on the basis of the attributes.

An information processing method according to a second example aspect includes:
acquiring avatar information including an appearance of an avatar linked to a user;
estimating attributes of the avatar on the basis of the avatar information; and
outputting request information for requesting content to be displayed for the user in a virtual space on the basis of the attributes.

A non-transitory computer readable medium according to a third example aspect is a non-transitory computer readable medium that stores an information processing program that causes a computer to execute:
acquiring avatar information including an appearance of an avatar linked to a user;
estimating attributes of the avatar on the basis of the avatar information; and
outputting request information for requesting content to be displayed for the user in a virtual space on the basis of the attributes.

According to the aforementioned aspects, it is possible to provide an information processing apparatus, an information processing method, and a non-transitory computer readable medium capable of suitably recognizing information regarding users that can be provided to advertisers and the like in a metaverse.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating, as an example, an information processing apparatus according to the present disclosure;

FIG. 2 is a flowchart illustrating, as an example, an information processing method using the information processing apparatus according to the present disclosure;

FIG. 3 is a block diagram illustrating, as an example, the information processing apparatus according to the present disclosure;

FIG. 4 is a block diagram illustrating, as an example, an information processing system according to the present disclosure;

FIG. 5 is a block diagram illustrating, as an example, the information processing system according to the present disclosure;

FIG. 6 is a diagram illustrating, as an example, attribute images generated by an image generation unit in the information processing system according to the present disclosure;

FIG. 7 is a flowchart illustrating, as an example, the information processing method using the information processing apparatus according to the present disclosure;

FIG. 8 is a diagram illustrating, as an example, an avatar information image generated by the image generation unit in the information processing system according to the present disclosure;

FIG. 9 is a block diagram illustrating, as an example, an information processing system according to the present disclosure; and

FIG. 10 is a block diagram illustrating, as an example, the information processing system according to the present disclosure.

### EXAMPLE EMBODIMENTS

### First Example Embodiment

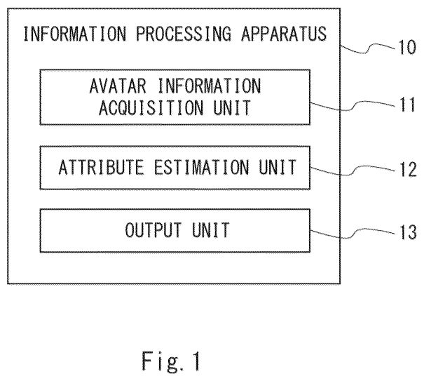

An information processing apparatus according to a first example embodiment will be described. FIG. 1 is a block diagram illustrating, as an example, an information processing apparatus 10 according to the present disclosure. As illustrated in FIG. 1, the information processing apparatus 10 includes an avatar information acquisition unit 11, an attribute estimation unit 12, and an output unit 13. The avatar information acquisition unit 11, the attribute estimation unit 12, and the output unit 13 have functions as an avatar information acquisition means, an attribute estimation means, and an output means, respectively.

The avatar information acquisition unit 11 acquires avatar information including an appearance of an avatar linked to a user. The attribute estimation unit 12 estimates attributes of the avatar on the basis of the avatar information. The output unit 13 outputs request information for requesting content to be displayed for the user in a virtual space on the basis of the attributes of the avatar.

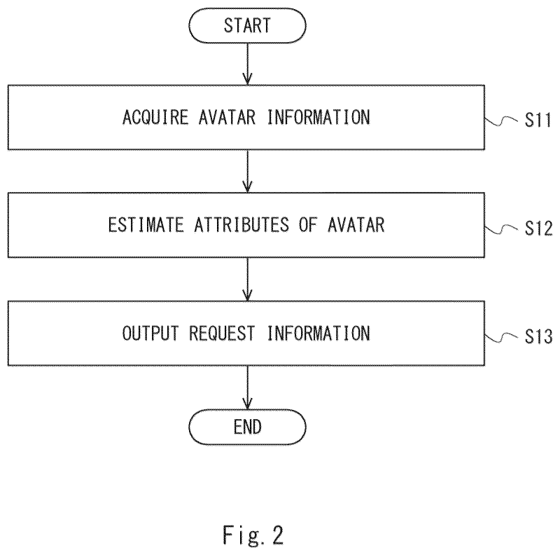

FIG. 2 is a flowchart illustrating, as an example, an information processing method using the information processing apparatus 10 according to the present disclosure. As illustrated in FIG. 2, the information processing method according to the present example embodiment executes Steps S11 to S13 using the information processing apparatus 10.

In Step S11, the avatar information acquisition unit 11 is caused to acquire avatar information including an appearance of an avatar linked to a user. In Step S12, the attribute estimation unit 12 is caused to estimate attributes of the avatar on the basis of the avatar information. In Step S13, the output unit 13 is caused to output request information for requesting content to be displayed for the user in a virtual space on the basis of the attributes of the avatar.

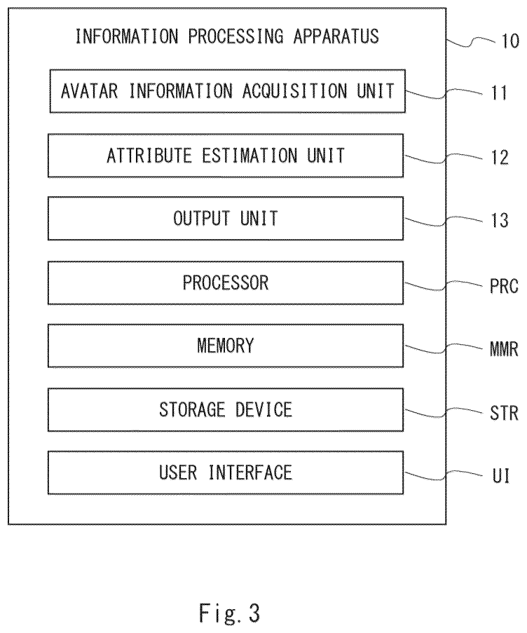

The information processing apparatus 10 described above may be, for example, an information processing device such as a server or a personal computer. FIG. 3 is a block diagram illustrating, as an example, the information processing apparatus 10 according to the present disclosure. As illustrated in FIG. 3, the information processing apparatus 10 may further include a processor PRC, a memory MMR, a storage device STR, and a user interface UI. The storage device STR stores, as a program, processing to be executed by each configuration of the information processing apparatus 10. Also, the processor PRC reads the program from the storage device STR to the memory MMR and executes the program. In this manner, the processor PRC realizes the functions of each configuration in the information processing apparatus 10, such as the avatar information acquisition unit 11, the attribute estimation unit 12, and the output unit 13. The user interface UI may include input devices such as a keyboard, a mouse, and an image capturing device and output devices such as a display, a printer, and a speaker.

Each configuration included in the information processing apparatus 10 may be realized by dedicated hardware. In addition, some or all of the components may be realized by general-purpose or dedicated circuitries, the processor PRC, or the like, or a combination thereof. These may be configured of a single chip or may be configured of a plurality of chips connected via a bus. Some or all of the components may be realized by a combination of the aforementioned circuitries or the like and the program. Furthermore, a central processing unit (CPU), a graphics processing unit (GPU), a field-programmable gate array (FPGA), a quantum processor (quantum computer control chip), or the like can be used as the processor PRC.

Also, in a case where some or all of the components of the information processing apparatus 10 is realized by a plurality of information processing apparatuses 10, circuitries, and the like, the plurality of information processing apparatuses 10, circuitries, and the like may be arranged in a centralized manner or in a distributed manner. For example, the information processing apparatuses 10, the circuitries, and the like may be realized in a form in which a client server system, a cloud computing system, or the like connects them via a communication network. Also, the functions of the information processing apparatus 10 may be provided in the form of software as a service (SaaS).

According to the present example embodiment, the information processing apparatus 10 acquires the avatar information including the appearance of the avatar and estimates the attributes of the avatar on the basis of the acquired avatar information. In this manner, content to be displayed for the user is requested on the basis of the estimated attributes of the avatar. The avatar linked to the user is closely related to the user, such as one selected by the user. Therefore, attributes of the avatar are intentionally or unintentionally related to the attributes of the user. Thus, it is possible to state that the avatar reflects at least a part of a mentality such as a buying motivation of the user. The information processing apparatus 10 requests content to be displayed for the user on the basis of attributes of such an avatar and can thus suitably recognize information regarding the user that can be provided to an advertiser and the like.

### Second Example Embodiment

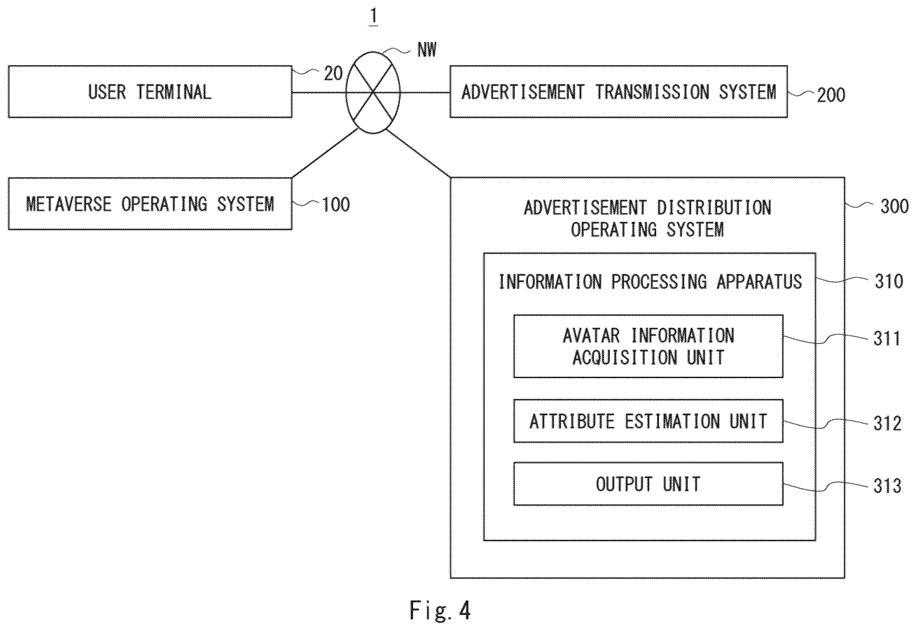

FIG. 4 is a block diagram illustrating, as an example, an information processing system 1 according to the present disclosure. As illustrated in FIG. 4, the information processing system 1 includes a user terminal 20, a metaverse operating system 100, an advertisement transmission system 200, an advertisement distribution operating system 300, and a network NW. The user terminal 20, the metaverse operating system 100, the advertisement transmission system 200, and the advertisement distribution operating system 300 are connected in a state where information can be mutually transmitted through the network NW having at least either wireless or wired communication lines.

The user terminal 20 is a terminal used by a user to operate an avatar in a virtual space. The user operates the avatar in the virtual space using the user terminal 20. The user terminal 20 includes, for example, a smartphone, a personal computer, and VR goggles.

The metaverse operating system 100 operates the virtual space. The metaverse operating system 100 includes, for example, an information processing apparatus such as a server. The metaverse operating system 100 provides the virtual space by the information processing apparatus. The user is connected to the information processing apparatus of the metaverse operating system 100 via the network NW such as the Internet. This allows the user to access the virtual space.

The advertisement transmission system 200 transmits advertisements to the virtual space. The advertisement transmission system 200 includes, for example, an information processing apparatus such as a server. The advertisement transmission system 200 may include a demand side platform (DSP) or may include an advertiser.

The advertisement distribution operating system 300 operates distribution of advertisements to the virtual space. The advertisement distribution operating system 300 may include, for example, a supply side platform (SSP) or may include an ad network. The advertisement distribution operating system 300 includes an information processing apparatus 310.

The information processing apparatus 310 includes an avatar information acquisition unit 311, an attribute estimation unit 312, and an output unit 313 similarly to the information processing apparatus 10. The avatar information acquisition unit 311 acquires avatar information including an appearance of an avatar in the virtual space. For example, the avatar information acquisition unit 311 acquires avatar information including what the avatar looks like, what the avatar is wearing, and the like, which are the appearance of the avatar. Note that the appearance of the avatar may include an appearance other than what the avatar looks like and what the avatar is wearing. For example, the appearance of the avatar may include animals such as monkeys and dogs in addition to humans or may include organisms including plants such as flowers and fishes such as fish. Furthermore, the appearance of the avatar may include inanimate objects such as a desk and a chair.

Also, the avatar information may include information other than the appearance of the avatar. For example, the avatar information acquisition unit 311 may acquire avatar information including a behavior history of the avatar. The behavior history may include at least any of features of an object that is present in a field of view of the avatar, a period of time during which the object that is present in the field of view of the avatar is present in the field of view of the avatar, and the distance between the object and the avatar, in addition to a behavior history such as eating and viewing. Furthermore, the behavior history may include at least any of content of utterances of the avatar and content of chatting of the avatar in addition to speaking and listening. The avatar information acquisition unit 311 may perform data extension from the information regarding the content of utterances or chatting of the avatar.

Note that the avatar information may include information other than the appearance of the avatar and the behavior history of the avatar. For example, the avatar information acquisition unit 311 may acquire, as the avatar information, physical data such as a line of sight, a heart rate, and brain waves of the user in addition to the information from the avatar. The avatar information acquisition unit 311 can use such various kinds of avatar information as materials to estimate the attributes of the avatar and can estimate the attributes of the avatar with high accuracy, by acquiring the avatar information.

The attribute estimation unit 312 estimates the attributes of the avatar on the basis of the avatar information including the appearance of the avatar acquired by the avatar information acquisition unit 311. The attribute estimation unit 312 may estimate the attributes of the avatar on the basis of the avatar information including the behavior history of the avatar acquired by the avatar information acquisition unit 311. In one example, the attribute estimation unit 312 estimates an age, a gender, and an occupation as attributes of the avatar from what the avatar looks like. In one example, the attribute estimation unit 312 estimates an age, a gender, and an occupation as attributes of the avatar from features of an object that is present on a line of sight of the avatar. Note that the attributes of the avatar may include a birthplace, a taste, and a preference in addition to the age, the gender, and the occupation. Furthermore, the attributes of the avatar may include animals, plants, fishes, organisms, inanimate objects, and the like.

The attribute estimation unit 312 may link the attributes of the avatar to the avatar information based on the estimation of the attributes of the avatar. For example, the attribute estimation unit 312 may link the age as an attribute of the avatar to what the avatar looks like as avatar information. Also, the attribute estimation unit 312 may link the gender as an attribute of the avatar to features of an object that is present on the line of sight of the avatar. The attribute estimation unit 312 may link a plurality of pieces of avatar information to one attribute of the avatar or may link one piece of avatar information to a plurality of attributes of the avatar.

The output unit 313 outputs, to the advertisement transmission system 200, request information for requesting content to be displayed for the user in the virtual space on the basis of the attributes of the avatar estimated by the attribute estimation unit 312. The request information may include the attributes of the avatar estimated by the attribute estimation unit 312. The request information may include the avatar information acquired by the avatar information acquisition unit 311. The output unit 313 may output information regarding the type of the content to be displayed for the user in the virtual space on the basis of the attributes of the avatar. The type of the content includes, for example, a type of an advertisement and includes a text advertisement, a movie advertisement, an image advertisement, a banner advertisement, or the like. Furthermore, the type of the content includes, for example, a genre of an advertisement and includes a genre of a product service as an advertisement target, such as automobiles, daily necessities, or entertainment.

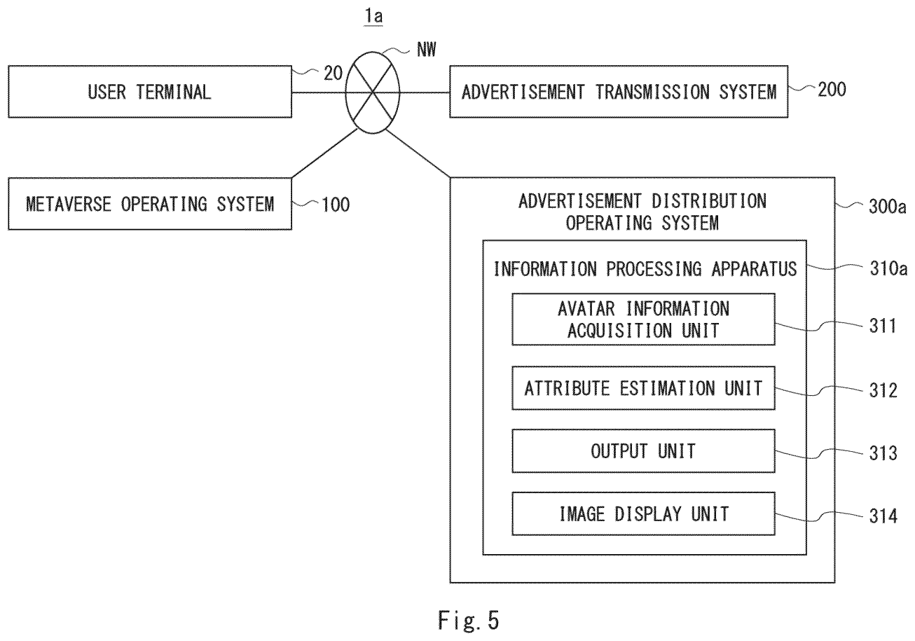

FIG. 5 is a block diagram illustrating, as an example, an information processing system 1a according to the present disclosure. As illustrated in FIG. 5, an information processing apparatus 310a further includes an image display unit 314 in an advertisement distribution operating system 300a. The image display unit 314 displays an attribute image to let the user visually recognize attributes included in the request information in the virtual space. In other words, the attribute image is displayed to let the user visually recognize the attributes included in the request information in the virtual space. The image display unit 314 may generate and display an attribute image or may select and display an attribute image stored in advance. Therefore, the image display unit 314 displays the attribute image caused to be generated or selected to let the user visually recognize the attributes included in the request information in the virtual space.

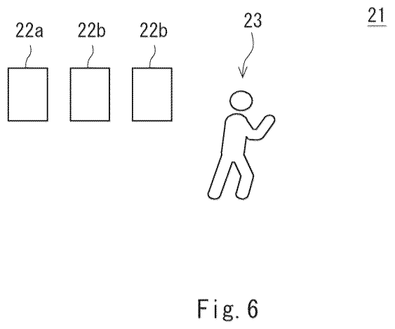

FIG. 6 is a diagram illustrating, as an example, attribute images 22a to 22c displayed by the image display unit 314 in the information processing system 1a according to the present disclosure. As illustrated in FIG. 6, the image display unit 314 may display the plurality of attribute images 22a to 22c. The plurality of attribute images 22a to 22c display a plurality of attributes of an avatar 23 estimated by the attribute estimation unit 312 to let the user visually recognize the attributes in a virtual space 21, respectively.

For example, the attribute image 22a is an image caused to be displayed to let the user to visually recognize an age as an attribute of the avatar 23 estimated by the attribute estimation unit 312 in the virtual space 21. The attribute image 22b is an image caused to be displayed to let the user to visually recognize a gender as an attribute of the avatar 23 estimated by the attribute estimation unit 312 in the virtual space 21. The attribute image 22c is an image caused to be displayed to let the user to visually recognize an occupation as an attribute of the avatar 23 estimated by the attribute estimation unit 312 in the virtual space 21.

The user may select, from among the plurality of attribute images 22a to 22c of the avatar 23, an attribute image displaying an attribute that may be output as request information to the advertisement transmission system 200 by the output unit 313. In a case where the request information including the age which is the attribute displayed in the attribute image 22a may be output to the advertisement transmission system 200 by the output unit 313, the user selects the attribute image 22a. In this case, the output unit 313 outputs request information for requesting content to be displayed for the user in the virtual space on the basis of attributes including the age. In this manner, the output unit 313 outputs the request information including the attribute displayed in the attribute image 22a selected by the user from among the plurality of attribute images 22a to 22c.

In this manner, it is possible to let the user select an attribute that may be output to the advertisement transmission system 200 and to thereby optimize information of the user that can be provided to an advertiser.

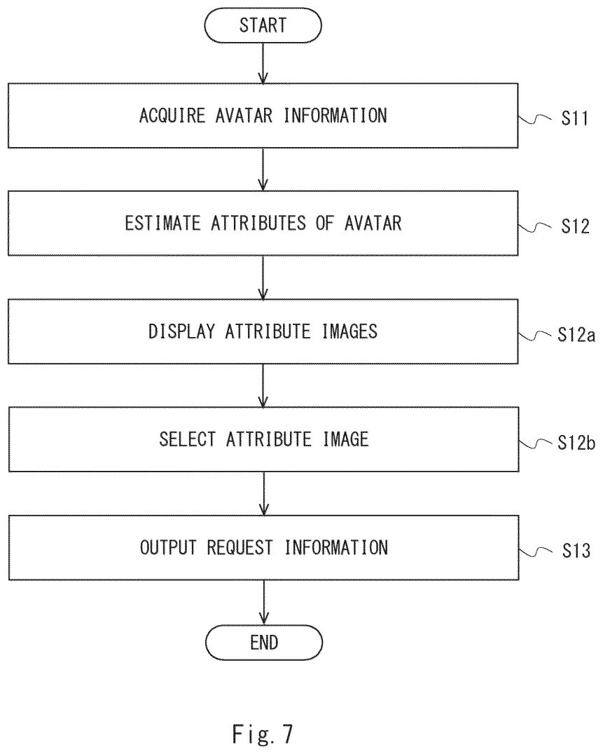

FIG. 7 is a flowchart illustrating, as an example, an information processing method using the information processing apparatus 310a according to the present disclosure. As illustrated in FIG. 7, the information processing method using the information processing apparatus 310a further includes Steps S12a and S12b as compared with the information processing method using the information processing apparatus 10 described above.

In Step S12a, the image display unit 314 is caused to display the attribute images 22a to 22c caused to be generated or selected to let the user visually recognize the attribute of the avatar 23 included in the request information in the virtual space 21. In Step S12a, the plurality of attribute images 22a to 22c caused to be generated or selected to let the user visually recognize each of the plurality of attributes estimated by the attribute estimation unit 312 in the virtual space 21.

In Step S12b, the user is caused to select the attribute images 22a to 22c displaying attributes that the output unit 313 may output as request information from among the plurality of attribute images 22a to 22c. In Step S13, the request information including the attribute displayed in the attribute images 22a to 22c selected by the user.

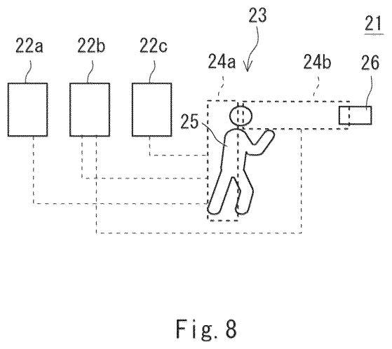

FIG. 8 is a diagram illustrating, as an example, avatar information images 24a and 24b displayed by the image display unit 314 in the information processing system 1a according to the present disclosure. As illustrated in FIG. 8, the image display unit 314 may display the plurality of avatar information images 24a and 24b. The plurality of avatar information images 24a and 24b display each of a plurality of pieces of avatar information, on the basis of which the attribute estimation unit 312 has estimated the attributes of the avatar 23, to let the user visually recognize the avatar information in the virtual space 21.

For example, the avatar information image 24a is an image displaying what the avatar 23 looks like 25 as avatar information, on the basis of which the attribute estimation unit 312 has estimated the age as an attribute of the avatar 23, to let the user visually recognize what the avatar 23 looks like 25 in the virtual space 21. The avatar information image 24b is an image displaying features of an object 26 that is present on a line of sight of the avatar 23 as avatar information, on the basis of which the attribute estimation unit 312 has estimated a gender as an attribute of the avatar 23, to let the user visually recognize the features in the virtual space 21.

In a case where the attributes of the avatar 23 are linked to the avatar information, on the basis of which the attributes of the avatar 23 have been estimated, the image display unit 314 displays the attribute images 22a to 22c and the avatar information images 24a and 24b displaying the avatar information linked to the attributes displayed in the attribute images 22a to 22c.

For example, the image display unit 314 displays the attribute image 22a displaying the age as an attribute of the avatar 23 and the avatar information image 24a displaying what the avatar 23 looks like 25 as avatar information in a linked manner. Here, what the avatar 23 looks like 25 displayed in the avatar information image 24a is linked to the age displayed in the attribute image 22a. For example, these are linked by a dashed line in the display. For example, the image display unit 314 displays the attribute image 22b displaying the gender as an attribute of the avatar 23 and the avatar information image 24b displaying the features of the object 26 that is present on the line of sight of the avatar 23 as avatar information in a linked manner. Here, the features of the object 26 displayed in the avatar information image 24b are linked to the gender displayed in the attribute image 22b. For example, these are linked by a dashed line in the display. In this manner, the image display unit 314 displays the plurality of avatar information images caused to be generated or selected to let the user visually recognize each of the plurality of pieces of avatar information, on the basis of which the attribute estimation unit 312 has estimated the attributes, in the virtual space. In a case where the attributes of the avatar are linked to the avatar information, on the basis of which the attributes of the avatar have been estimated, the image display unit 314 displays the attribute images and the avatar information images displaying the avatar information linked to the attributes of the avatar displayed in the attribute images.

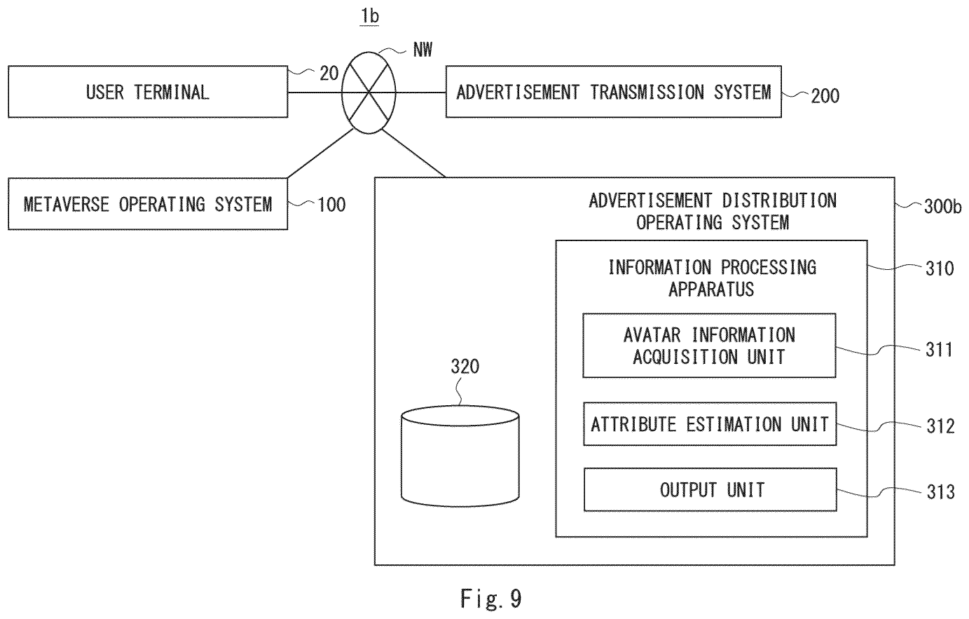

FIG. 9 is a block diagram illustrating, as an example, an information processing system 1b according to the present disclosure. As illustrated in FIG. 9, an advertisement distribution operating system 300b may include an attribute database 320. An information processing apparatus 310 is connected to the attribute database 320 in a state where information can be transmitted therebetween. Note that the information processing apparatus 310 may include the attribute database 320.

An attribute estimation unit 312 may estimate attributes of an avatar 23 by making reference about features of an appearance of an avatar 23 to the predetermined attribute database 320. The attribute database 320 may include attributes of the avatar 23 linked to other users. The attributes of the avatar 23 linked to other users may include tastes and preferences. The attribute database 320 includes attributes of the avatar 23 linked to other users with appearances that are similar to the appearance of the avatar 23 of the user.

Next, effects of the present example embodiment will be described. An avatar information acquisition unit 311 acquires avatar information including various types of behavior histories and the like of the avatar 23 in addition to the appearance of the avatar 23. Therefore, the attribute estimation unit 312 can estimate the attributes of the avatar 23 with high accuracy. The information processing apparatus 310 can thus suitably recognize information of the user that can be provided to an advertiser and the like.

The attribute estimation unit 312 estimates the attributes of the avatar 23 by making reference to the attribute database 320. In this manner, it is possible to use data regarding the avatar 23 linked to other users with appearances similar to the appearance of the avatar 23 of the user and to thereby estimate the attributes of the avatar 23 with yet higher accuracy. The output unit 313 may output information regarding the type of content to be displayed for the user in the virtual space 21. It is thus possible to cause display suitable for the user to be provided.

An image display unit 314 causes attribute images 22a to 22c to be displayed to let the user visually recognize attributes of the avatar 23 included in request information in the virtual space 21. Therefore, the user can check the attributes of the avatar 23 included in the request information. Also, the image display unit 314 causes the plurality of attribute images 22a to 22c to be displayed to let the user visually recognize each of a plurality of attributes estimated by the attribute estimation unit 312 in the virtual space 21. In this manner, the user can pick up attributes of the avatar 23 to be included in the request information before the output unit 313 outputs the request information.

The image display unit 314 causes a plurality of avatar information images 24a and 24b to let the user visually recognize each of a plurality of pieces of avatar information, on the basis of which the attribute estimation unit 312 has estimated the attributes of the avatar 23, in the virtual space 21. Then, the image display unit 314 displays the attribute images 22a to 22c and the avatar information images 24a and 24b in a linked manner. Therefore, the user can check the avatar information used by the attribute estimation unit 312 to select the attributes of the avatar 23 to be included in the request information. It is thus possible to suitably recognize information of the user that can be provided to an advertiser and the like. Other configurations and effects are included in the description of the first example embodiment.

### Third Example Embodiment

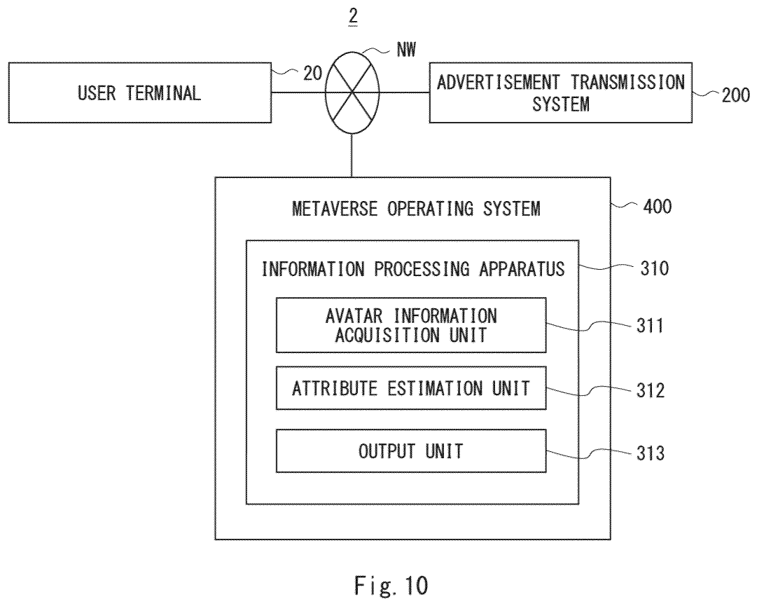

FIG. 10 is a block diagram illustrating, as an example, an information processing system 2 according to the present disclosure. As illustrated in FIG. 10, the information processing system 2 includes a user terminal 20, an advertisement transmission system 200, a metaverse operating system 400, and a network NW. The user terminal 20, the advertisement transmission system 200, and the metaverse operating system 400 are connected in a state where information can be mutually transmitted through the network NW having at least either wireless or wired communication lines.

In the information processing system 2 in the present example embodiment, the metaverse operating system 400 includes an information processing apparatus 310. In this manner, a configuration in which the metaverse operating system 400 includes the information processing apparatus 310 may be adopted. It is thus possible to improve a degree of freedom in configuration of the information processing system 2. Other configurations and effects are included in the description of the first and second example embodiments.

Although the present disclosure has been described hitherto with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each drawing is merely illustrative for describing one or more example embodiments. Each drawing is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing illustrative example embodiments are not necessarily mandatory, and some features or steps may be omitted. The order of the steps described in any drawing may be changed as appropriate.

Although some or all of the above-described example embodiments may be described as in the following Supplements, the present disclosure is not limited to the following Supplements.

### (Supplementary Note 1)

An information processing apparatus including:
at least one memory that stores instructions; and
at least one processor that is configured to execute the instructions to;
acquire avatar information including an appearance of an avatar linked to a user,
estimate attributes of the avatar on the basis of the avatar information, and
output request information for requesting content to be displayed for the user in a virtual space on the basis of the attributes.

### (Supplementary Note 2)

The information processing apparatus according to Supplementary Note 1, in which
the at least one processor executes the instructions to
acquire the avatar information including a behavior history of the avatar, and
the behavior history includes at least any of features of an object that is present in a field of view of the avatar, a period of time during which the object is present in the field of view, and a distance between the object and the avatar.

### (Supplementary Note 3)

The information processing apparatus according to Supplementary Note 1, in which
the at least one processor executes the instructions to
acquire the avatar information including a behavior history of the avatar, and
the behavior history includes at least any of content of utterances of the avatar and content of chatting of the avatar.

### (Supplementary Note 4)

The information processing apparatus according to Supplementary Note 1, in which
the at least one processor executes the instructions to
estimate the attributes of the avatar by making reference about features of an appearance of the avatar to a predetermined attribute database, and
the attribute database includes
tastes and preferences of the avatar linked to other users, and
data of avatars linked to the other users with appearances similar to an appearance of the avatar of the user.

### (Supplementary Note 5)

The information processing apparatus according to Supplementary Note 1, in which the at least one processor executes the instructions to output information regarding a type of the content to be displayed for the user in the virtual space on the basis of the attributes.

### (Supplementary Note 6)

The information processing apparatus according to Supplementary Note 1, in which the at least one processor executes the instructions to display an attribute image that is caused to be generated or selected to let the user visually recognize the attributes included in the request information in the virtual space.

### (Supplementary Note 7)

The information processing apparatus according to Supplementary Note 6, in which
the at least one processor executes the instructions to
display a plurality of the attribute images that are caused to be generated or selected to let the user visually recognize each of the plurality of estimated attributes in the virtual space, and
output the request information including the attributes displayed in the attribute image selected by the user from among the plurality of attribute images.

### (Supplementary Note 8)

The information processing apparatus according to Supplementary Note 7, in which
the at least one processor executes the instructions to
display a plurality of avatar information images that are caused to be generated or selected to let the user visually recognize each of a plurality of pieces of the avatar information, on the basis of which the attributes have been estimated, in the virtual space, and
in a case where the attributes and the avatar information, on the basis of which the attributes have been estimated, are linked, the attribute images and the avatar information images that are caused to display the avatar information linked to the attributes displayed in the attribute images are displayed in a linked manner.

### (Supplementary Note 9)

An information processing method including:
acquiring avatar information including an appearance of an avatar linked to a user;
estimating attributes of the avatar on the basis of the avatar information; and
outputting request information for requesting content to be displayed for the user in a virtual space on the basis of the attributes.

### (Supplementary Note 10)

A non-transitory computer readable medium that stores an information processing program that causes a computer to execute:
acquiring avatar information including an appearance of an avatar linked to a user;
estimating attributes of the avatar on the basis of the avatar information; and
outputting request information for requesting content to be displayed for the user in a virtual space on the basis of the attributes.

Some or all of the elements described in Supplementary Notes 2 to 8 depending from Supplementary Note 1 may depend from Supplementary Notes 9 and 10 as well with depending relationships similar to those of Supplementary Notes 2 to 8. Some or all of the elements described in any supplementary notes may be applied to various kinds of hardware, software, recording means for recording software, systems, and methods.

Furthermore, an information processing program that causes a computer to read and execute the aforementioned information processing method is also within the scope of the technical idea of the example embodiments. The information processing program may be stored in a non-transitory computer readable medium or a tangible storage medium. As an example and not by way of limitation, the computer readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage apparatus. The information processing program may be transmitted on a transitory computer readable medium or a communication medium. By way of example, and not limitation, transitory computer readable or communication media include electrical, optical, acoustic, or other forms of propagated signals.

What is claimed is:

1. An information processing apparatus comprising:
at least one memory that stores instructions; and
at least one processor that is configured to execute the instructions to;
acquire avatar information including an appearance of an avatar linked to a user,
estimate attributes of the avatar on the basis of the avatar information, and
output request information for requesting content to be displayed for the user in a virtual space on the basis of the attributes.

2. The information processing apparatus according to claim 1, wherein
the at least one processor executes the instructions to
acquire the avatar information including a behavior history of the avatar, and
the behavior history includes at least any of features of an object that is present in a field of view of the avatar, a period of time during which the object is present in the field of view, and a distance between the object and the avatar.

3. The information processing apparatus according to claim 1, wherein
the at least one processor executes the instructions to
acquire the avatar information including a behavior history of the avatar, and
the behavior history includes at least any of content of utterances of the avatar and content of chatting of the avatar.

4. The information processing apparatus according to claim 1, wherein
the at least one processor executes the instructions to
estimate the attributes of the avatar by making reference about features of an appearance of the avatar to a predetermined attribute database, and
the attribute database includes
tastes and preferences of the avatar linked to other users, and
data of avatars linked to the other users with appearances similar to an appearance of the avatar of the user.

5. The information processing apparatus according to claim 1, wherein the at least one processor executes the instructions to output information regarding a type of the content to be displayed for the user in the virtual space on the basis of the attributes.

6. The information processing apparatus according to claim 1, wherein the at least one processor executes the instructions to display an attribute image that is caused to be generated or selected to let the user visually recognize the attributes included in the request information in the virtual space.

7. The information processing apparatus according to claim 6, wherein
the at least one processor executes the instructions to
display a plurality of the attribute images that are caused to be generated or selected to let the user visually recognize each of the plurality of estimated attributes in the virtual space, and
output the request information including the attributes displayed in the attribute image selected by the user from among the plurality of attribute images.

8. The information processing apparatus according to claim 7, wherein
the at least one processor executes the instructions to
display a plurality of avatar information images that are caused to be generated or selected to let the user visually recognize each of a plurality of pieces of the avatar information, on the basis of which the attributes have been estimated, in the virtual space, and
in a case where the attributes and the avatar information, on the basis of which the attributes have been estimated, are linked, the attribute images and the avatar information images that are caused to display the avatar information linked to the attributes displayed in the attribute images are displayed in a linked manner.

9. An information processing method comprising:
acquiring avatar information including an appearance of an avatar linked to a user;
estimating attributes of the avatar on the basis of the avatar information; and
outputting request information for requesting content to be displayed for the user in a virtual space on the basis of the attributes.

10. A non-transitory computer readable medium that stores an information processing program that causes a computer to execute:
acquiring avatar information including an appearance of an avatar linked to a user;
estimating attributes of the avatar on the basis of the avatar information; and
outputting request information for requesting content to be displayed for the user in a virtual space on the basis of the attributes.
